(19) United States
(12) Patent Application Publication
(10) Pub. No.: US 2008/0301810 A1
(43) Pub. Date: Dec. 4, 2008

(54) MONITORING APPARATUS AND METHOD THEREFOR

(75) Inventors: Andrew Lehane, Milnathort (GB); Martin Curran-Gray, Dunfermline (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/132,438

(22) Filed: Jun. 3, 2008

(30) Foreign Application Priority Data
Jun. 4, 2007 (GB) 0710620.6

(51) Int. Cl. G06F 21/00

(52) U.S. Cl. 726/23

(57) ABSTRACT

A monitoring apparatus for detection of a malicious attack in a communications network comprises a pattern matching engine (406), a data store (408) and an alert generator (410, 412). The pattern matching engine (406) is arranged to receive a bit stream and identify a characteristic of a malicious attack from at least one datagram represented by at least part of the bit stream. The data store (408) is operably coupled to the pattern matching engine and the data store (408) is arranged to retain identification data to enable the pattern matching engine to identify the characteristic of the malicious attack. The alert generator (410, 412) is arranged to generate an alert in response to an identification of the characteristic of the malicious attack. The data store (408) is remotely updatable.

The present invention relates to a monitoring apparatus for detection of malicious attacks, for example, of a type originating from compromised host systems and that are under the control of a remote computer, such as a Distributed Denial of Service attack. The present invention also relates to a communications system comprising the monitoring apparatus and a method of detecting a malicious attack.

In the field of network communications, so-called “Denial of Service” (DoS) attacks take several forms. The most common type of attack attempts to prevent external access to enterprise networks, e-commerce or public web sites by flooding them with large amounts of traffic, resulting in legitimate users being unable to gain access to a site that is the target of an attack, hence the term “Denial of Service”. These attacks consist of sending packets such as TCP-SYN requests or PINGs with false source addresses to which the target site or network (“the target”) must provide a response. For example, one type of attack, known as a “flooding attack” involves the Internet link of the target being flooded by an onslaught of false TCP-SYN requests that keep a network device at the target, and indeed the CPU supporting the network device, busy answering spurious connection requests. In some cases, the attacks also send specially devised malformed packets that remote software services are unable to process and can either crash the service running on a host system, or in the worst case the host system itself. These are known as protocol attacks. The specially devised packets can be very simple, for example Windows NT and 95,and early 2.0.x Linux, Solaris x86, and Macintosh systems will all crash if a PING packet larger than the maximum size of 65535 bytes is received. This is colloquially known as a “Ping of Death”.

A Distributed Denial of Service (DDoS) attack uses the same method as a regular DoS attack, but it is launched from multiple sources. As an initial step, an attacker attempts to infiltrate unsuspecting host systems (hereafter “hosts”) with fast network connections using known security loopholes, thereby compromising the hosts. After gaining access, the attacker installs software onto the compromised hosts. These newly installed software services act as agents, or “slaves”, that lie dormant on the hosts until they are given a command from a remote source, known as a “master”. The master orders each slave to run a single DoS attack against a specified target. A number of slaves, ranging from just a few, to many tens or hundreds, can be used in a single attack; a target can therefore be “blasted” with malicious packets from multiple hosts.

With the proliferation of cable modems, Digital Subscriber Line (DSL) Internet access, the ready availability of powerful hacking tools and vulnerable, i.e. un-patched, hosts, there are plenty of easily accessible hosts with fast connections to the Internet that could be used as potential attack slaves. The key to a DDOS attack is that an assault from a single host will not be able to overwhelm a potential victim with a high bandwidth Internet connection. However, thousands of such attacks originating from many host systems spread all over the globe can soon overpower the potential victim.

Success of a DDOS attack depends upon whether or not the potential victim has more bandwidth available than the aggregate bandwidth at the disposal of the attacker. Ultimately, a determined attacker is likely to win, simply due to attackers being able to compromise many vulnerable hosts and use them as slaves to mount a concerted distributed attack. There is no way that any individual enterprise or site can stop attacks and so they rely upon one or more of a number of measures available to them to defend themselves. The measures available include a combination of firewalls, scanners and intrusion detection systems to stop the attacks penetrating a network.

In relation to prevention, ISPs wishing to trace originators of DoS attacks and other malevolence, such as virus and worm attacks need to recognise an attack as it is occurring. This is relatively easy when close to the target; the arrival of large numbers of suspect packets is indicative of a possible attack. However, at the target, the process of filtering packets and tracing the source is difficult, because a very large number of packets can be sent from various geographical and topologically disparate compromised hosts and so a firewall might be overwhelmed when attempting to filter the attack packets, ironically making the attack a success. Also, almost all packets sent by attacking hosts use “spoofed” source IP addresses, i.e. false source IP addresses are used, making tracing of the source of the attack extremely difficult.

Clearly, if the source of an attack can be discovered, a system administrator can inform owners of any subverted hosts and attempt to identify the party that compromised the hosts. Even if the source cannot be identified, it is still nevertheless possible to apply a filter closer to the origin of the attack packets, a solution that inherently has improved efficiency and less impact on network elements due to the overall filtering effort being distributed and more closely targeted.

Several defensive technologies exist that offer protection against attacks and some help track down the source of an assault. Such defensive types of system rely on protecting an enterprise network or site at connection points between the enterprise network or site and the wider Internet. Examples of these types of defensive technologies include anti-virus applications, anti-spyware applications, anti-phishing applications, firewalls, intrusion detection systems and scanners.

A firewall is the first line of defence of an enterprise or a site and defines permitted incoming and outgoing connections, whilst helping to prevent intrusion that would be required to plant agent or zombie programs on a network behind the firewall. During an attack, a firewall, assuming it has been configured correctly, will bear the brunt of the attack and should recognise flooding attacks and drop packets constituting the flooding attack before they penetrate the network. Most commercial firewalls can also be set to notify the system administrator that the attack is underway. However, the most important feature of the firewall in this type of attack may be the ability of the firewall to log suspicious traffic. Firewalls, however, are not a complete solution, because a skilled attacker or someone who has downloaded good tools can easily overcome the protection provided by the best firewalls if vulnerabilities exist on a network.

Another type of defensive system is a so-called “scanner” application, which searches a site or enterprise network for vulnerabilities and tells the system administrator how to fix them. Scanners also scan the enterprise network for existing back doors and DDoS agents or slaves alerting the administrator so that they can be removed.

Intrusion Detection Systems (IDS) are another type of defensive system that monitor all packets that go to network segments or hosts, and try to identify scanning attempts upon those networks that are hoping to exploit vulnerability, irrespective of whether or not the particular vulnerability exists.

In order for an attacker to place distributed slaves into a network, the attacker must first penetrate the network and gain access to one or more general purpose computing devices on the network on that network, for example a Personal Computer (PC), a process that breaks down into several stages. During each stage, it is possible to search for signature packets that are indicative of the attack. Consequently, the IDS scan packets and is programmed to recognise the process of penetrating the network being monitored. Once a machine is compromised, the assailants often repeat the process giving the IDS further opportunities to uncover an attack.

In summary, threats against corporate and personal data stored on computers are on the rise and an increasing amount of sensitive information is vulnerable to theft. As a result, more and more companies and individuals may suffer financial loss because of attacks on computer systems and networks.

As mentioned above, protecting such sensitive data requires a variety of approaches including anti-virus, anti-spyware, anti-phishing capabilities, firewalls, and intrusion detection systems. Some of these provide remedial protection; others take a more active, preventive role.

According to a first aspect of the present invention, there is provided a monitoring apparatus for detection of a malicious attack in a communications network, the apparatus comprising: a pattern matching engine arranged to receive a bit stream and identify a characteristic of a malicious attack from at least one datagram represented by at least part of the bit stream; a data store operably coupled to the pattern matching engine, the data store being arranged to retain identification data to enable the pattern matching engine to identify the characteristic of the malicious attack; and an alert generator arranged to generate an alert in response to an identification of the characteristic of the malicious attack; wherein the data store is remotely updatable.

The apparatus may further comprise a data updating entity operably coupled to the data store and arranged to receive a plurality of datagrams comprising replacement identification data.

The data updating entity may be arranged to store the replacement identification data in place of the identification data.

The pattern matching engine may be arranged to cease identifying the characteristic of the malicious attack in response to receipt of a datagram of the plurality of datagrams comprising the replacement identification data. The pattern matching engine may be arranged to revert to identifying the characteristic of the malicious attack upon confirmed replacement of the identification data with the replacement identification data. The confirmed replacement of the identification data may be confirmed successful replacement of the identification data.

The apparatus may further comprise: a sub-channel injector entity for supporting a sub-channel within a main channel, the main channel supporting receipt of the bit stream. The sub-channel may be arranged to be used for communication of acknowledgement data responsive to a datagram comprising a part of the replacement data.

The data updating entity may be operably coupled to the sub-channel injector entity and is arranged to generate the acknowledgement data and communicate the acknowledgement data to the sub-channel injector entity.

According to a second aspect of the invention, there is provided a processing resource for a network element, the resource comprising the monitoring apparatus as set forth above in relation to the first aspect of the invention.

According to a third aspect of the invention, there is provided an interface card for a network element comprising the processing resource as set forth above in relation to the first aspect of the invention.

According to a fourth aspect of the invention, there is provided a communications system comprising the monitoring apparatus as set forth above in relation to the first aspect of the invention.

According to a fifth aspect of the invention, there is provided a method of detecting a malicious attack in a communications network, the method comprising: receiving a bit stream; identifying a characteristic of a malicious attack from at least one datagram represented by at least part of the bit stream; accessing identification data stored by a data store to enable identification of the characteristic of the malicious attack; and generating an alert in response to an identification of the characteristic of the malicious attack; and recognising a received datagram containing replacement identification data indicative of a need to update the data store.

According to a sixth aspect of the invention, there is provided a monitoring apparatus for detection of a malicious attack in a communications network, the apparatus comprising: a pattern matching engine arranged to receive a bit stream and identify a characteristic of a malicious attack from at least one datagram represented by at least part of the bit stream; an alert generator arranged to generate an alert in response to an identification of the characteristic of the malicious attack; and an alert processing entity operably coupled to the alert generator, the alert processing entity being arranged to receive the alert constituting alert information and limit communication of the alert information for receipt by an alert information collection unit.

The alert information collection unit may not be collocated with the alert processing entity within the topology of the communications network.

The alert processing entity may be arranged to generate a digest of alert information received in respect of a plurality of alerts generated by the alert generator.

The digest may comprise one or more of the following parameters: a used port number, duration of a plurality of packets constituting the malicious attack, an identity of a link being monitored, a location of the monitoring apparatus in the communications network, data identifying a type of the characteristic detected, a rate of receipt of datagrams containing a same type of the characteristic detected, a number of sources of datagrams containing the characteristic detected, a number of destinations of datagrams containing the characteristic detected, and/or datagram length.

The alert processing unit may be arranged to communicate the alert information in response to receipt of multiple receipts of the alert exceeding a predetermined threshold.

The alert processing entity may be arranged to have a latched state corresponding to a part of the alert information received, the latched state being entered in response to an initial receipt of the part of the alert information received and remain in the latched state during subsequent receipts of the same part of the alert information.

The apparatus may further comprise: a sub-channel injector entity for supporting a sub-channel within a main channel, the main channel supporting receipt of the bit stream.

The sub-channel injector may be operably coupled to the alert processing entity, the alert processing entity being arranged to use the sub-channel to communicate the alert information.

According to a seventh aspect of the invention, there is provided a processing resource for a network element, the resource comprising the monitoring apparatus as set forth above in relation to the sixth aspect of the invention.

According to an eighth aspect of the invention, there is provided an interface card for a network element comprising the processing resource as set forth above in relation to the sixth aspect of the invention.

According to an ninth aspect of the invention, there is provided a communications system comprising the monitoring apparatus as set forth above in relation to the sixth aspect of the invention. The system may further comprise: an alert information collection unit remotely located from the monitoring apparatus at a monitoring station; wherein the monitoring station is arranged to communicate instruction data to the monitoring apparatus in response to receipt of the alert information.

The instruction data may identify an action to be taken by the monitoring apparatus in relation to the at least one datagram baring the characteristic of the malicious attack.

The action may at least mitigate and/or neutralise an intended effect of the malicious attack.

The response to the receipt of the alert information may be automated.

The monitoring station may be arranged to communicate the alert information to a user, the monitoring station providing the user with freedom to select and initiate communication of the instruction data.

According to a tenth aspect of the invention, there is provided a method of detecting a malicious attack in a communications network, the method comprising: receiving a bit stream; identifying a characteristic of a malicious attack from at least one datagram represented by at least part of the bit stream; generating an alert in response to an identification of the characteristic of the malicious attack; recognising a received datagram containing replacement identification data indicative of a need to update the data store; and processing the alert constituting alert information and limiting communication of the alert information for receipt by an alert information collection unit

According to an eleventh aspect of the invention, there is provided a computer program element comprising computer program code means to make a computer execute the method as set forth above in relation to the tenth aspect of the invention. The computer program code element may be embodied on a computer readable medium.

It is thus possible to provide a monitoring apparatus, communications system and method that are capable of detecting attacks in a dynamically adaptable way through maintenance of “rules” employed to detect such attacks. Consequently, better policing of a network, such as the Internet, is possible. It is further possible to provide, relatively quickly, information concerning the malicious attack to a service provider, such as an Internet Service Provider, so that rapid action can be taken to suppress the malicious attack, for example by filtering out malicious traffic addressed to a target host network. Furthermore, treatment of datagrams in the communications network is not effected, nor are any protocol changes required. Of particular advantage is an absence of a need for additional fields to be added to existing packets. Also, overlay networks are not required, and management overhead is not increased considerably. Both real-time and post-mortem analysis is possible, and the apparatus and method are passive in nature, making them harder to exploit for malicious purposes. The solution of the present invention also allows viruses and worms to be detected and their respective sources identified.

At least one embodiment of the invention will now be described, by way of example only, with reference to the accompanying drawings, in which:

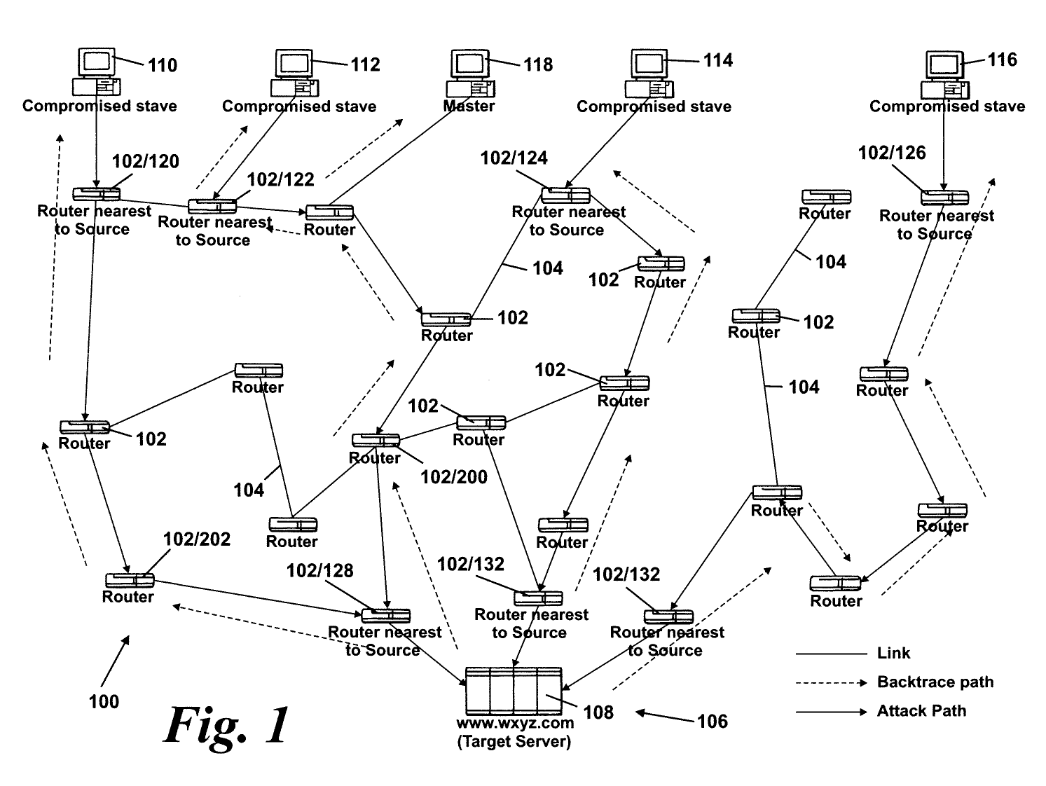

FIG. 1 is a schematic diagram of a part of a communications network;

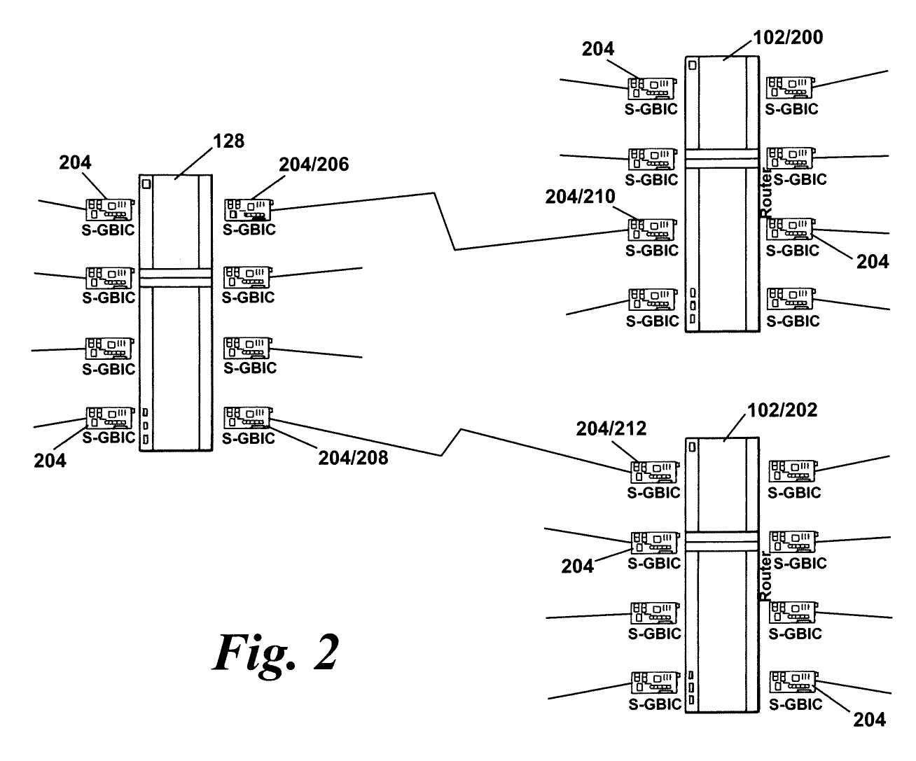

FIG. 2 is a schematic diagram of a number of network elements of FIG. 1 in greater detail;

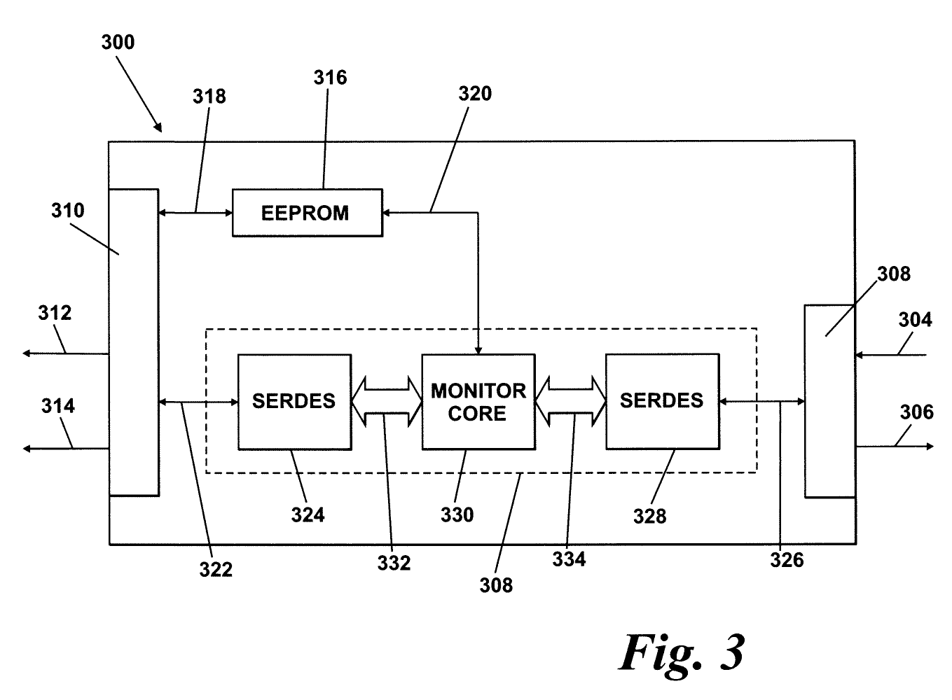

FIG. 3 is a schematic diagram of an enhanced GBIC for monitoring networks;

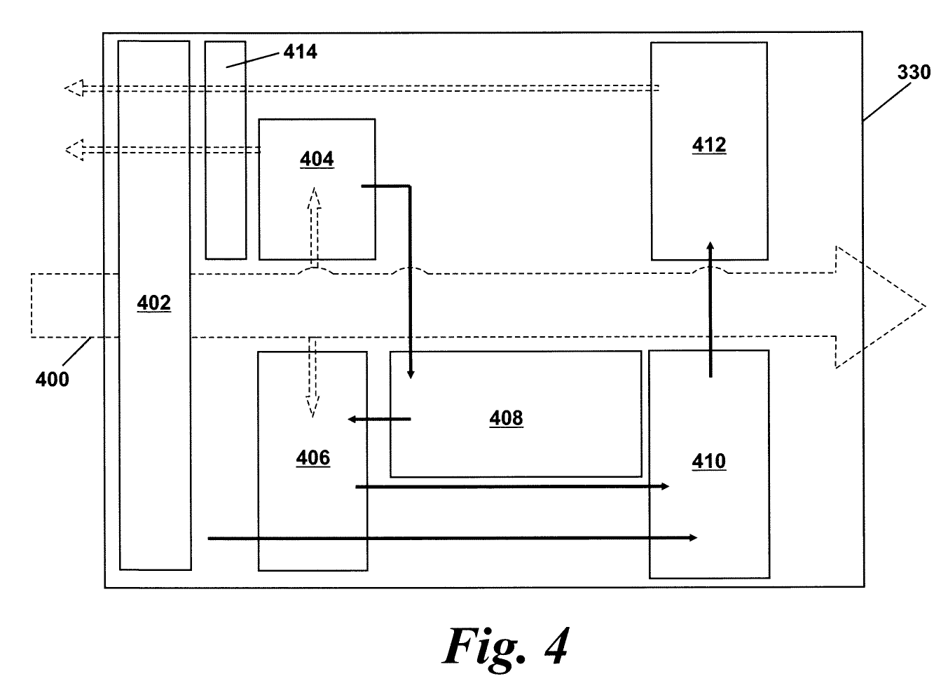

FIG. 4 is a schematic diagram of part of the enhanced GBIC of FIG. 3 in greater detail and constituting an embodiment of the invention;

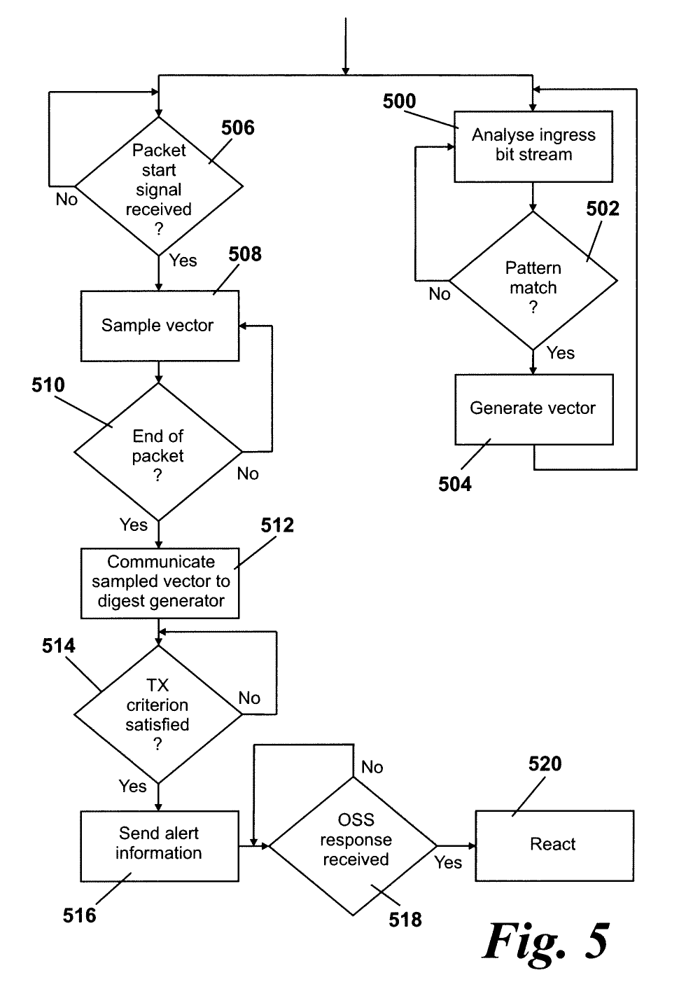

FIG. 5 is flow diagram of a method of generating alerts using the apparatus of FIG. 4;

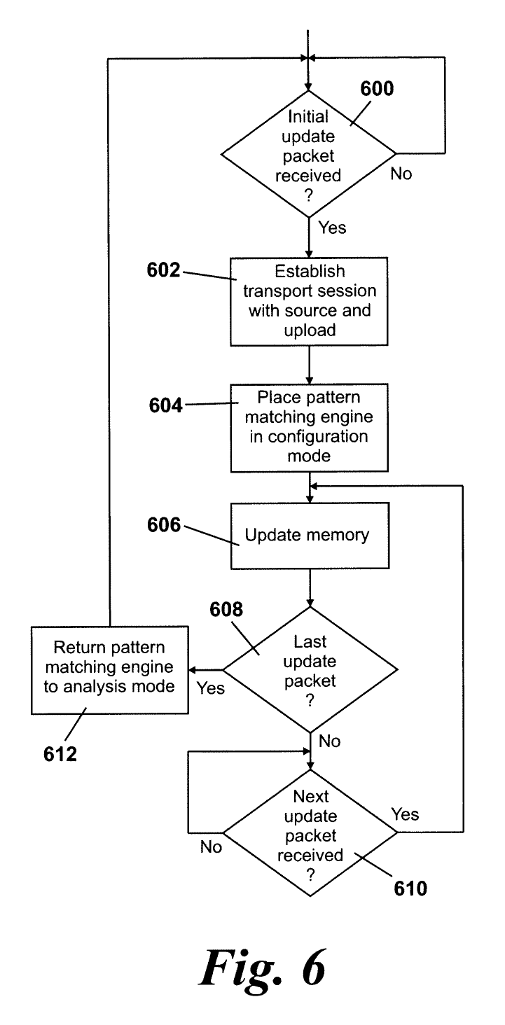

FIG. 6 is flow diagram of a method of updating the apparatus of FIG. 4.

Throughout the following description identical reference numerals will be used to identify like parts.

Referring to FIG. 1, a communications network 100, for example the Internet, comprises a plurality of network elements, for example routers 102, interconnected by communications links 104.

A target host system 106, for example a target server 108, that is the target of a malicious network attack, for example a Distributed Denial of Service (DDOS) attack, is coupled, through the routers 102, to a first compromised slave computer 110, a second compromised slave computer 112, a third compromised slave computer 114, and a fourth compromised slave computer 116. In this example, the first, second, third and fourth slave computers 110, 112, 114, 116 are networked computers, such as Personal Computers (PCs) or servers having access to an Internet Service Provider. In each case, the PCs or servers constituting the first, second, third and fourth slave computers 110, 112, 114, 116 have had their respective security measures compromised and a software application uploaded onto them and executed for the purpose of transmitting packets to the target server 108 under the control of a so-called “master” 118, the packets (hereafter “malicious packets”) being designed to disrupt or totally prevent the service being provided by the target server 108 either by occupying the target server 108 with illegitimate processing requests, overloading it completely or by causing the target server 108 to crash through receipt of intentionally malformed packets. Of course, for a DDOS attack to succeed, a larger number of compromised slave devices are usually employed, but in this description the number has been limited to four compromised slave computers in order to preserve simplicity and clarity of description.

In relation to the master 118, the master 118 is also a networked computer, such as a PC. The master 118 executes a controlling software application that is capable of communicating with the first, second, third and fourth slave computers 110, 112, 114, 116 in order to control malicious attacks implemented by the slave computers 110, 112, 114, 116, for example the malicious attack on the target server 108.

Each of the first, second, third and fourth slave computers 110, 112, 114, 116 is respectively coupled to a first, second, third and fourth source-nearest router 120, 122, 124, 126. Similarly, the target server 108 is coupled to a first, second and a third target-nearest routers 128,130, 132.

Turning to FIG. 2, the first target-nearest router 128 is coupled to two other, topologically adjacent, routers 102, for example a first adjacent router 200 and a second adjacent router 202. In this example, each of the first adjacent router 200, the second adjacent router 202 and the first target-nearest router 128 comprise a plurality of interface converter modules 204. In particular, the target-nearest router 128 has a first interface converter module 206 and a second interface converter module 208 via which the target-nearest router 128 is able to communicate with the first adjacent router 200, via a first interface converter module 210 of the first adjacent router 200, and the second adjacent router 202, via a first interface converter module 212 of the second adjacent router 202.

The interface converter modules 204, 206, 208, 210, 212 are enhanced programmable monitoring devices based upon, for example, GigaBit Interface Converters (GBICs) that permit receipt and transmission of communications signals between the first adjacent router 200, the second adjacent router 202 and the first target-nearest router 128. Other routers 102 in the communications network possessing the interface converter modules 204 are also interconnected in this way.

Referring to FIG. 3, the enhanced interface converter modules 204, 300 are based upon standard interface converter modules that can be obtained from a number of manufacturers, such as Finisar Corporation and E2O Communications Inc. The enhanced interface converter module 300 is a hot swappable plug-in full duplex electrical-to-optical converter. The interface converter 300 receives light at and light is emitted from a first interface 302 via optical fibre connections 304 and 306 respectively, forming a network-side full duplex serial connection. The interface converter 300 also receives electrical signals at and transmits electrical signals from a second interface 310 via an output electrical connection 312 and an input electrical connection 314 respectively, forming a host-side full duplex serial connection. The first interface 302 controls optical transmitters and detectors (not shown), known in relation to existing interface converter modules, to perform appropriate optical-to-electrical and electrical-to-optical conversions. Likewise, the second interface 310 translates electrical signals on the output and input electrical connections 312, 314 to and from a form suitable to pass to the first interface 302 or be used by a router, respectively. An Electrically Erasable Programmable Read Only Memory (EEPROM) 316 contains manufacturing and device identification that is presented via a first internal connection 318 to the second interface 310. The details of how this information is recovered, and other ancillary services, for example power supplies, are not pertinent to the invention and so will not be described in further detail. The interface converter module is supplemented by an additional processing capability 308 inserted between the first and second interfaces 302, 310. The additional processing capability 308 is coupled to the first interface 302 by a second connection 316, the additional processing capability 308 being coupled to the second interface 310 by a third electrical connection 322. Electrical serial data signals on the second electrical connections 826 are fed to a first SERialiser-DESerialiser (SERDES) device 328 and electrical signals of the third electrical connection 322 are fed to a second SERDES 324. The first and second SERDES devices 328, 324 take high-speed serial information and present it at a lower data rate on first and second parallel buses 334, 332, respectively for passing to a monitor core 330. Conversely, the SERDES devices 328, 324 also take parallel information at the lower data rate from the monitor core 330 via the first and second parallel busses 334, 332 respectively, and serialise the lower data rate data for driving on to the first and second electrical connections 326, 322. Traffic arriving at the monitor core 330 from the host-side connection via the second SERDES device 324 is passed through generally unmodified to the network-side connection via the first SERDES 328. Similarly, traffic arriving from the network-side connection destined for the host-side connection is passed through generally unmodified via the first and second SERDES devices 328, 326.

By using gaps in active data flowing through the enhanced interface converter module 300, extra packets can be sent over and above those that are being communicated on a link used to communicate the active data. In this respect, the enhanced converter module 300 comprises an in-line sub-channel apparatus (not shown in FIG. 3) that supports a sub-channel in a main channel, the main channel being used to communicate the active data. An example of support for the in-line sub-channel apparatus is described in EP-A1-1 524 807. Although the structure and operation of the in-line sub-channel apparatus is well-documented in EP-A1-1 524 807, for the sake of ease of reference and ready understanding of the use of the sub-channel described later herein, the structure of the in-line sub-channel apparatus will now be briefly described. Of course, the skilled person will recognise that the functionality of the in-line sub-channel apparatus can be modified to include only some of the functionality described in EP-A1-1 524 807.

As described in EP-A1-1 524 807, the in-line sub-channel apparatus exploits idle periods on the first main channel to support the first sub-channel. The in-line sub-channel apparatus comprises a sub-channel injector coupled to an application logic that uses the sub-channel supported by the sub-channel injector. The application logic serves as a processing resource.

Also, messages specifically intended for receipt by the monitor core 330 can be removed from the flow of the active data if required by the enhanced interface converter module 300. The monitor core 330 is programmable and provides suitable services for receiving and interpreting, and generating and transmitting messages to allow the enhanced interface converter module 300 to interact with other enhanced interface converter modules, as well as other devices provisioned to control devices or collections of devices. An EEPROM connection 320 can optionally be provided between the EEPROM 316 and the monitor core 330 in order to recover data from the EEPROM 316 to inform the monitor core 330 of its role in the network in which the enhanced interface converter module is currently inserted.

The interface converter modules 204, 300 each comprise a processing resource, such as the additional processing capability described above, which is further enhanced to support a monitoring process to detect malicious network attacks, the processing resource being structured as follows. Optionally, a Field Programmable Gate Array can be integrated into the interface converter module 204, 300 if insufficient processing power is available. Of course, the skilled person will appreciate that other devices can be employed, for example an Application Specific Integrated Circuit (ASIC).

Referring to FIG. 4, the monitor core 330 comprises a data bus 400, supporting communication of a received bit stream therealong, is coupled to a framer-deframer module 402. The framer-deframer module 402 is capable of encapsulating data exiting the monitor core 330 in an Ethernet frame, for example in accordance with the IEEE 802.3 standard. Similarly, the framer-deframer module 402 is capable of removing frame data from Ethernet frames entering the monitor core 330.

The data bus 400 is also coupled to an updater module 404 and a pattern matching engine 406. The updater module 404 and the pattern matching engine 406 are capable of communicating with a data store 408, for example a memory unit, such as a Random Access Memory (RAM). The pattern matching engine 406 is also operably coupled to packet sampler module 410, the packet sampler module 410 being coupled to the framer-deframer module 402 and a digest generator module 412. The digest generator module 412 and the updater module 404 are also coupled to the sub-channel injector 414. The digest generator module 412 and the packet sampler module 410 constitute, in this example, an alert processing entity. However, in other embodiments, either or both of the digest generator module 412 and the packet sampler module 410 can constitute the alert processing entity.

In operation (FIG. 5), the communications network 100 operates in a state prior to a launch of a malicious attack on the target server 108. As it is not relevant to the operation of the above apparatus, the manner in which the first slave computer 110, the second slave computer 112, the third slave computer 114 and the fourth slave computer 116 have been compromised will not be described. However, it should be understood that the master 118 sends commands to the first slave computer 110, the second slave computer 112, the third slave computer 114 and the fourth slave computer 116 in order to identify the target server 108 as the victim of a malicious attack and the frequency of transmission of packets to the target server 108.

Upon transmission of the identity, i.e. the Internet Protocol (IP) address, of the target server 108 to the slave computers 110, 112, 114, 116 and the ferocity of the attack, for example the type of packet to be sent and the frequency of transmission, the compromised slave computers 110, 112, 114, 116 begin transmission of packets to the target server 108. The malicious attack on the target server 108 is therefore underway.

Referring back to FIG. 1, paths taken by the malicious packets originating from the compromised slave computers 110, 112, 114, 116 to the target server 108 are shown as solid arrows. The malicious packets traverse a number of the routers 102 en route to the target server 108, presenting several opportunities for detection of the malicious attack.

The malicious packets sent from the slave computers 110, 112, 114, 116 from topologically and geographically disparate locations converge on the target server 108 as the malicious packets get closer to the target server 108. Consequently, the target-nearest routers 128, 130, 132 experience a higher level of received traffic than the source-nearest routers 120, 122, 124, 126, the level of received traffic experienced by routers 102 between the source-nearest routers 120, 122, 124, 126, and the target-nearest routers 128, 130, 132 increasing the closer the router 102 is to the target server 108.

Therefore, routers 102 of differing distances from the target server 108 will respectively receive differing quantities of malicious packets. In this respect, a small number of suspicious packets received by a router 102 does not give a high degree of confidence that a malicious attack is in progress, whereas a much higher number of suspicious packets would be far more telling.

In this example, the monitor core 330 monitors ingress traffic to the interface converter module 204, 300 in which the processing resource 300 is disposed for suspicious packets or activities in relation to packets, for example, unusual traffic patterns. Upon receipt of a stream of packets corresponding to the ingress traffic represented by the bit stream, the pattern matching engine 406 analyses the bit stream in order to detect one or more patterns, for example, in a part of the bit stream corresponding to a payload of a packet, that constitute a characteristic of a malicious attack. Due to size constraints of the data store 408, the pattern matching engine operates in accordance with an efficient data compression methodology. In this respect, identification data used by the pattern matching engine to identify characteristics of malicious attacks are compressed in an efficient manner to facilitate storage of a sufficient amount of identification data.

The compressed identification is, inter alia, treated as a sparse array for compression purposes. The pattern matching engine 406 is a Finite State Machine (FSM) that uses the identification data to identify one or more pattern in the bit stream in order to determine if at least one datagram represented by at least part of the bit stream bares a characteristic of a malicious attack.

Prior to uploading code constituting the pattern matching engine 406 and the identification data to the monitor core 330, the source code and the identification data are pre-processed by a Java-based program running on a PC with the RAM tables created as appropriately sized arrays for the data store 408 in order to configure the pattern matching engine 406 to be able to handle the identification data in accordance to the compression technique(s) employed to compress the identification data. The configured source code and the identification data are then compiled into VHSIC Hardware Description Language (VHDL) object code for uploading to the monitor core 330 using any suitable technique for uploading the object code.

Continuing with the operation of this monitor core 330, the bit stream is received by monitor core 330 via the data bus 400, whereupon bits identified as relating to framing data are removed from the bit stream, the remaining raw data bits being communicated on the data bus 400. Thereafter, the pattern matching engine analyses (Step 500) the bit stream to identify one or more patterns in the bit stream indicative of the existence of a malicious attach borne by at least one datagram represented by at least part of the bit stream. The pattern matching engine 406 obtains the identification data that enables the pattern matching engine to identify the one or more patters from the data store 408. In the event that the pattern matching engine 406 identifies a pattern in the at least part of the bit stream (Step 502) indicative of the malicious attack, pattern matching engine 406 outputs a match vector (Step 504) to the packet sampler module 410. The match vector comprises ‘n’ bits, each respectively corresponding to a pattern that can be matched. The patterns to be matched can be perceived as rules, in the same way as a firewall has “rules”. With the passage of time, the match vector can change as the pattern matching engine 406 matches one or more additional pattern in the bit stream over succeeding clock cycles. Consequently, the packet sampler module receives start and stop signals (Step 506) from the framer-deframer module 402 indicative of a start of a packet and an end of the packet to enable the packet sampler module 410 to know the period over which to observe the match vector so as to be in respect of a given packet. Hence, the match vector is sampled (Step 508) over a duration corresponding to receipt of a packet.

In this example, the packet sampler module 410 is implemented as a series of flip-flops (not shown) providing a latching capability for each bit of the match vector. Consequently, as the match vector changes from clock cycle-to-clock cycle, the packet sampler module 410 retains the knowledge that a given bit has been flagged to indicate detection of a given pattern by the pattern matching engine within the scope of a sampling period. Additionally, the use of the latch mechanism obviates recordal of repeated instances of detection of a given pattern.

Once the end of the packet has been signalled by the framer-deframer module 402 (Step 510), the packet sampler module 410 communicates the sampled match vector to the digest generator module 412 (Step 512). The digest generator module 412 receives sampled match vectors and uses the sub-channel described above to communicate alert information constituting representing the received sampled match vectors to a remote monitoring station, for example an Operational Support Systems (OSS) centre. At the OSS centre, an alert information collection unit (not shown) is provided for receiving the alert information.

Due to the possible high frequency of generation of the sampled match vectors repeatedly identifying a same pattern corresponding to a malicious attack as a result of successive packets baring the same pattern, the digest generator module 412, in this example, monitors generation of sampled match vectors and limits communication of the alert information in relation to a same pattern identified by the pattern match engine 406. For example, the digest generator module 412 can start recording occurrences of the same pattern match above a first threshold detection rate. Additionally or alternatively, the digest generator module 412 sends the alert information (Step 516) summarising receipt of multiple alerts in the form of sampled match vectors from the packet sampler module 410 once the number of occurrences of the pattern match reach a predetermined level or satisfy another criterion (Step 514). The alert information, when providing a summary, can include a number of measures related to the repeated receipt of the same pattern match, for example: data identifying a type of the characteristic detected, a rate of receipt of packets containing a same type of the characteristic detected, a number of sources of packets containing the characteristic detected, a number of destinations of packets containing the characteristic detected, packet length, used port numbers, duration of a plurality of packets constituting the malicious attack, an identity of a link being monitored and/or a location of enhanced interface converter module 300 in the communications network.

At the OSS centre, the alert information collection unit can be configured to automatically respond to the alert information received from the digest generator module 412 by sending an instruction to the monitor core 330 to take a course of action (Steps 518, 520) to mitigate and/or neutralise the effect of the packet containing the pattern indicative of the malicious attack. In this respect, possible course of action include dropping the packet, or throttle packets relating to the malicious attack. Alternatively, the information collection unit can be configured to provide an alert message to a human operator requesting a response to the detected threat. The human operator can then decide if action is necessary and decide upon the best course of action. Once the best course of action has been decided upon, an appropriate instruction can be communicated to the monitor core 330. By involving the human operator, the response to “false positives” can be mitigated.

Of course the effectiveness of the above-described activity is dependent upon the rules/patterns stored by the data store 408 remaining up-to-date. In this respect, it is desirable to maintain the patterns stored by the data store 408 in order to be able to handle new threats to the network 100. In this respect, so-called “on-the-fly” reprogramming is performed by sending new identification data to the monitor core 330 as a stream of unicast packets. Referring to FIG. 6, the new identification data is in a compressed form compatible with the previous configuration of the pattern matching engine 406. A pre-processing software function also encapsulates the new identification information into a series of sequenced packets. Due to the high level of compression involved and the limited size of the data store 408, a piecemeal update of patterns is not feasible in this example and a complete set of patterns is sent to the monitor core 330 irrespective of whether an individual pattern has changed or not.

At the monitor core 330, the updater module 404 implements a state machine to parse incoming packets for frames that are sent to a MAC address of the enhanced interface converter module 300 and that use a known Ethernet type (Ethertype) length type value and valid CRC value. This information is used by the updater module 404 to recognise a first packet (Step 600) of the series of sequenced packets as such.

In this example, the updater module 404 implements rules similar to the Internet Engineering Task Force (IETF) Transmission Control Protocol (TCP) (Step 602) to ensure safe delivery of the series of sequenced packets. Consequently, in response to safe receipt of the first packet of the series of sequenced packets, the updater module 404 generates an acknowledgement message that is communicated to the sub-channel injector 414 for communication back to a source of the series of sequenced packets, for example the OSS centre, using the sub-channel. In accordance with the transport mechanism supported by the updater module 404, subsequent packets in the series of sequenced packets are communicated to the monitor core 330 upon receipt of acknowledgements from the updater module 404. When an acknowledgement is not received, a given packet for which no acknowledgement has been received is re-sent. The last packet in the series of sequenced packets is appropriately marked with a special flag, for example in a header of the last packet.

Additionally, once the first packet of the series of sequenced packets has been received, the updater module 404 places the pattern matching engine 406 in a configuration mode (Step 604), causing the pattern matching engine 406 to cease matching patterns in the received bit stream so that spurious matches cannot be generated during reconfiguration of the monitor core 330 when the contents of the data store 308 will be inconsistent. However, it should be noted that the monitor core 330 continues to permit normal traffic to pass therethrough. In order to avoid memory contention, a tri-state bus addressing scheme is employed in relation to the data store 408 so that the data store can be accessed by both the pattern matching engine 406 and the updater module 404.

For additional security, a token, or key, based authentication system is used to ensure the validity of the source of the series of sequenced packets in order to avoid attackers using the configuration mode to avoid detection by placing the monitor probe 330 into configuration mode and, as a consequence, the pattern matching engine 406 offline. In this respect, the validity of the source of the series of sequenced packets can be verified as well as the contents of the series of sequenced packets by using a PGP signature, Simple Authentication and Security Layer (SSAL) or Message Authentication Code. Signed packets ensures that the data that arrives at the monitor core 330 was sent by a bona-fide source and has not been modified en-route.

In this example, each packet relating to the series of sequenced packets contains one half of a RAM block. Upon safe receipt of the first packet, updater module 404 loads (Step 606) the content of the first packet, relating to the identification information, into an appropriate block of the data store 408. Thereafter, the updater module 404 determines (Step 408) whether the packet just used to update the data store 408 is the last packet of the series of sequenced packets. If the packet being analysed is not the last packet of the series of sequenced packets, the updater module 404 awaits (Step 610) receipt of a next packet of the series of sequenced packets. Upon receipt of the next packet of the series of sequenced packets, the content of the next packet is also loaded (Step 606) into another appropriate block of the data store 408. Thereafter, the updater module 404 returns to determining (Step 606) whether the next packet of the series of sequenced packets is, in fact, the last packet of the series of sequenced packets.

The above loop is repeated until the last packet of the series of sequenced packets is received and the contents thereof loaded into the data store 408. As described above, the updater module 404 determines (Step 606) that the last packet of the series of sequenced packets received is indeed the last packet to be received in relation to the identification information and so the updater module 404 places the pattern matching engine 406 back into an active monitoring mode (Step 612) so as to continue parsing the bit stream. However, the parsing of the bit stream is now in accordance with the new identification information stored in the data store 408. The updater module 404 continues to await further updates (Step 600).

The above activity, described in relation to the first adjacent router 200, is also carried out by the first interface converter module 212 of the second adjacent router 202. Indeed, all routers 102 in the communications network 100 comprising the enhanced network interface modules described above in relation to FIGS. 3 and 4 are capable of generating alerts and being updated in the manner described above. Additionally, it should be appreciated that whilst the above example only describes a single malicious attack, the above apparatus and method can handle multiple simultaneous detections of suspicious network activity. Further, although the above examples employ the same identification data in relation to all interface converter modules, it should be appreciated that different interface converter modules can operate using different identification information. For example, identification information can be deployed differently, such as different identification information stored by different interface converter modules, and in a strategic manner, such as a topologically strategic manner, in order to mitigate, or neutralise, the effects of a malicious attack.

Whilst the above examples have been described in the context of packet communication, it should be appreciated that the term “packet” is intended to be construed as encompassing packets, datagrams, frames, cells, and protocol data units and so these term should be understood to be interchangeable.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A monitoring apparatus for detection of a malicious attack in a communications network, the apparatus comprising:
a pattern matching engine arranged to receive a bit stream and identify a characteristic of a malicious attack from at least one datagram represented by at least part of the bit stream;
a data store operably coupled to the pattern matching engine, the data store being arranged to retain identification data to enable the pattern matching engine to identify the characteristic of the malicious attack; and
an alert generator arranged to generate an alert in response to an identification of the characteristic of the malicious attack; wherein
the data store is remotely updatable.

2. An apparatus as claimed in claim 1, further comprising a data updating entity operably coupled to the data store and arranged to receive a plurality of datagrams comprising replacement identification data.

3. An apparatus as claimed in claim 2, wherein the data updating entity is arranged to store the replacement identification data in place of the identification data.

4. An apparatus as claimed in claim 2, wherein the pattern matching engine is arranged to cease identifying the characteristic of the malicious attack in response to receipt of a datagram of the plurality of datagrams comprising the replacement identification data.

5. An apparatus as claimed in claim 4, wherein the pattern matching engine is arranged to revert to identifying the characteristic of the malicious attack upon confirmed replacement of the identification data with the replacement identification data.

6. An apparatus as claimed in claim 1, further comprising:
a sub-channel injector entity for supporting a sub-channel within a main channel, the main channel supporting receipt of the bit stream.

7. An apparatus as claimed in claim 6, wherein the sub-channel is arranged to be used for communication of acknowledgement data responsive to a datagram comprising a part of the replacement data.

8. An apparatus as claimed in claim 7, wherein the data updating entity is operably coupled to the sub-channel injector entity and is arranged to generate the acknowledgement data and communicate the acknowledgement data to the sub-channel injector entity.

9. A processing resource for a network element, the resource comprising the monitoring apparatus as claimed in claim 1.

10. An interface card for a network element comprising the processing resource as claimed in claim 9.

11. A communications system comprising the monitoring apparatus as claimed in claim 1.

12. A method of detecting a malicious attack in a communications network, the method comprising:
receiving a bit stream;
identifying a characteristic of a malicious attack from at least one datagram represented by at least part of the bit stream;
accessing identification data stored by a data store to enable identification of the characteristic of the malicious attack; and
generating an alert in response to an identification of the characteristic of the malicious attack; and
recognising a received datagram containing replacement identification data indicative of a need to update the data store.

13. A monitoring apparatus for detection of a malicious attack in a communications network, the apparatus comprising:
a pattern matching engine arranged to receive a bit stream and identify a characteristic of a malicious attack from at least one datagram represented by at least part of the bit stream;
an alert generator arranged to generate an alert in response to an identification of the characteristic of the malicious attack; and
an alert processing entity operably coupled to the alert generator, the alert processing entity being arranged to receive the alert constituting alert information and limit communication of the alert information for receipt by an alert information collection unit.

14. An apparatus as claimed in claim 13, wherein the alert information collection unit is not collocated with the alert processing entity within the topology of the communications network.

15. An apparatus as claimed in claim 13, wherein the alert processing entity is arranged to generate a digest of alert information received in respect of a plurality of alerts generated by the alert generator.

16. An apparatus as claimed in claim 15, wherein the digest comprises one or more of the following parameters: a used port number, a duration of a plurality of packets constituting the malicious attack, an identity of a link being monitored, location of the monitoring apparatus in the communications network, data identifying a type of the characteristic detected, a rate of receipt of datagrams containing a same type of the characteristic detected, a number of sources of datagrams containing the characteristic detected, a number of destinations of datagrams containing the characteristic detected, and/or datagram length.

17. An apparatus as claimed in claim 14, wherein the alert processing unit is arranged to communicate the alert information in response to receipt of multiple receipts of the alert exceeding a predetermined threshold.

18. An apparatus as claimed in claim 13, further comprising:
a sub-channel injector entity for supporting a sub-channel within a main channel, the main channel supporting receipt of the bit stream.

19. An apparatus as claimed in claim 18, wherein the sub-channel injector is operably coupled to the alert processing entity, the alert processing entity being arranged to use the sub-channel to communicate the alert information.

20. A processing resource for a network element, the resource comprising the monitoring apparatus as claimed in claim 13.

21. An interface card for a network element comprising the processing resource as claimed in claim 20.

22. A communications system comprising the monitoring apparatus as claimed in claim 13, the system further comprising:
an alert information collection unit remotely located from the monitoring apparatus at a monitoring station; wherein
the monitoring station is arranged to communicate instruction data to the monitoring apparatus in response to receipt of the alert information.

23. A system as claimed in claim 22, wherein the instruction data identifies an action to be taken by the monitoring apparatus in relation to the at least one datagram baring the characteristic of the malicious attack.

24. A system as claimed in claim 23, wherein the action at least mitigates and/or neutralises an intended effect of the malicious attack.

25. A system as claimed in claim 22, wherein the response to the receipt of the alert information is automated.

26. A system as claimed in claim 22, wherein the monitoring station is arranged to communicate the alert information to a user, the monitoring station providing the user with freedom to select and initiate communication of the instruction data.

27. A method of detecting a malicious attack in a communications network, the method comprising:
receiving a bit stream;
identifying a characteristic of a malicious attack from at least one datagram represented by at least part of the bit stream;
generating an alert in response to an identification of the characteristic of the malicious attack;
recognising a received datagram containing replacement identification data indicative of a need to update the data store; and
processing the alert constituting alert information and limiting communication of the alert information for receipt by an alert information collection unit.

28. A computer program element embodied on a computer readable medium, comprising computer program code means to make a computer execute the method of claim 12.

29. A computer program code element embodied on a computer readable medium, comprising computer program code means to make a computer execute the method of claim 27.

30. An apparatus as claimed in claim 13, wherein the alert information causes the monitoring apparatus to take an action, the action at least mitigating and/or neutralising an intended effect of the malicious attack.

31. An apparatus as claimed in claim 13, wherein the alert information causes the monitoring apparatus to drop a packet relating to the malicious attack.
